(19) United States
(12) Patent Application Publication
(10) Pub. No.: US 2006/0086567 A1
(43) Pub. Date: Apr. 27, 2006

(54) Fall prevention construction for antenna structure

(76) Inventor: Joseph F. Deuer, Kettering, OH (US)

Correspondence Address: STEVENS & SHOWALTER LLP, 7019 CORPORATE WAY, DAYTON, OH, 45459-4238, US

(21) Appl. No.: 10/974,160

(22) Filed: Oct. 27, 2004

(51) Int. Cl. A62B 37/00

(52) U.S. Cl. 182/8

(57) ABSTRACT

A fall prevention construction for attachment to a vertical tower including a radio-frequency wave antenna. The fall prevention construction includes a safety rope having first and second ends, and upper and lower anchor members for attachment to the first and second ends, respectively. The safety rope includes a dry finish polyester core material and an outer jacket is formed over the safety rope and extends substantially the length of the safety rope for preventing moisture from contacting the safety rope. At least the first end of the safety rope is formed in a loop for connecting engagement with a cooperating member of the upper anchor member. Sleeve members surround a terminal portion of the first end and a laterally adjacent section of the safety rope, where the sleeve members are swaged into contact with the terminal portion and the laterally adjacent section. A water barrier surrounds the terminal portion of the first end, the laterally adjacent section of the safety rope and the sleeve members. The water barrier includes a potting material substantially filling spaces between the terminal portion, the laterally adjacent section and the sleeve members.

### BACKGROUND OF THE INVENTION

1. Field of the Invention

The present invention relates to safety devices, and more particularly, to a fall prevention construction for providing fall prevention to persons climbing vertical antenna structures.

2. Description of the Prior Art

Workers employed to perform construction and maintenance on elevated structures are typically in need of some form of fall prevention system. Such fall prevention systems are preferably permanently installed on the structure in order to ensure the availability of a safety mechanism to the worker at all times, including when climbing the structure. In the case of some structures, it has not been possible or convenient to provide fall prevention systems for the entire height of the structure due to the nature of the operations performed by the structure. For example, vertical television broadcasting towers having top mounted antennas have historically not included permanent fall prevention systems in that fall prevention systems have typically included a metal cable extending vertically along a side of the structure, which are known to distort the radio waves transmitted by the antenna. Therefore, in some instances it has been necessary to exclude a safety cable type fall prevention system along at least a portion of the television broadcasting tower which includes the vertical transmission area of the antenna. Not only does this pose an increased safety risk to workers, but the worker is also usually required to work on the tower in the dark, during early morning hours when the antenna is not transmitting, in order to avoid exposing the worker to harmful radiation energy. Accordingly, workers on such transmission towers are subjected to increased risks in the absence of an adequate and durable fall prevention mechanism.

In an attempt to address this need, U.S. Pat. No. 5,964,316 has proposed a fall prevention system in which a rope is provided in place of a steel or aluminum cable. A specific rope is provided comprising a polyurethane resin impregnated aramid fiber core, such as a Kevlar® rope, covered by a protective jacket of polyurethane. Grip clips are engaged with end portions of the rope to form loops at the end portions for engagement with mounting hardware of the system. While the '316 patent provides an alternative to the prior metal cable systems, there remains a potential source of cable degradation in the event the exterior of the rope is damaged by the grip clips. For example, if a breach occurs in the surface of the jacket for the rope, such as at the attachment point of the grip clips, water may seep inside the jacket and form a media to be excited by radio waves, resulting in heating of the safety rope, including the surrounding jacket, during activation of the antenna.

Accordingly, there remains a need for a durable safety system capable of being used in an adverse environment formed by radio frequency energy transmissions on tower structures.

### SUMMARY OF THE INVENTION

The present invention provides a fall prevention construction for permanent attachment to a vertical tower, where the fall prevention construction includes a rope for receiving a security device attached to a worker, the security device being freely slidable along the rope except if the worker should begin to fall, in which case the security device grips the rope to prevent the worker from falling. The present fall prevention construction is particularly designed for use with a tower supporting a radio-frequency wave antenna such that radio waves from the antenna will impinge on the rope portion of the fall prevention construction.

In one aspect of the invention, a fall prevention construction for permanent attachment to a vertical tower including a radio-frequency wave antenna is provided. The fall prevention construction comprises a safety rope having first and second ends, and upper and lower anchor members for attachment to the first and second ends, respectively. The safety rope comprises a dry finish polyester core material, and an outer jacket is formed over the safety rope for preventing moisture from contacting the safety rope.

In another aspect of the invention, a fall prevention construction for permanent attachment to a vertical tower including a radio-frequency wave antenna is provided including a safety rope having first and second ends, and upper and lower anchor members for attachment to the first and second ends, respectively. An outer jacket is formed over the safety rope for preventing moisture from contacting the safety rope. At least the first end of the safety rope is formed in a loop for connecting engagement with a cooperating member of the upper anchor member, the loop being located adjacent a terminal portion of the first end and a laterally adjacent section of the safety rope. In addition, a water barrier surrounds the terminal portion of the first end and the laterally adjacent section of the safety rope.

In a further aspect of the invention, a fall prevention construction attached to a vertical tower including a radio-frequency wave antenna is provided including a safety rope having first and second ends, and upper and lower anchor members for attachment to the first and second ends, respectively. The safety rope comprises a dry finish polyester core material and an outer jacket is formed over the safety rope and extends substantially the length of the safety rope for preventing moisture from contacting the safety rope. At least the first end of the safety rope is formed in a loop for connecting engagement with a cooperating member of the upper anchor member, where the loop is located adjacent a terminal portion of the first end and a laterally adjacent section of the safety rope. Sleeve members surround the terminal portion of the first end and the laterally adjacent section of the safety rope, where the sleeve members are swaged into contact with the terminal portion and the laterally adjacent section. In addition, a water barrier surrounds the terminal portion of the first end, the laterally adjacent section of the safety rope and the sleeve members. The water barrier comprises a potting material substantially filling spaces between the terminal portion, the laterally adjacent section and the sleeve members.

Other features and advantages of the invention will be apparent from the following description, the accompanying drawings and the appended claims.

### BRIEF DESCRIPTION OF THE DRAWINGS

FIG. 1 is a side elevational view of the fall prevention construction of the present invention, shown mounted to a vertical antenna tower;

FIG. 2 is a partial cut-away view of a rope structure for the fall prevention construction;

FIG. 3 is a side elevational view of an upper end of a safety rope for the fall prevention construction;

FIG. 4 is a side elevational view of an upper end connection for the fall prevention construction in which the outer cover at the upper end of the safety rope is shown in phantom lines;

FIG. 5 is a front elevational view of the upper end connection for the fall prevention construction in which the outer cover at the upper end of the safety rope is shown in phantom lines;

FIG. 6 is an end view of a connecting sleeve for the fall prevention construction prior to swaging of the sleeve;

FIG. 7 is a plan view of the connecting sleeve for the fall prevention construction prior to swaging of the sleeve;

FIG. 8 is a cross-sectional view taken along line 8-8 in FIG. 5, showing the swaged sleeve member prior to installation of the cover and potting material;

FIG. 9 is a cross-sectional view taken along line 9-9 in FIG. 4, illustrating a waterproof barrier formed around the end of the rope for the fall prevention construction.

### DETAILED DESCRIPTION OF THE INVENTION

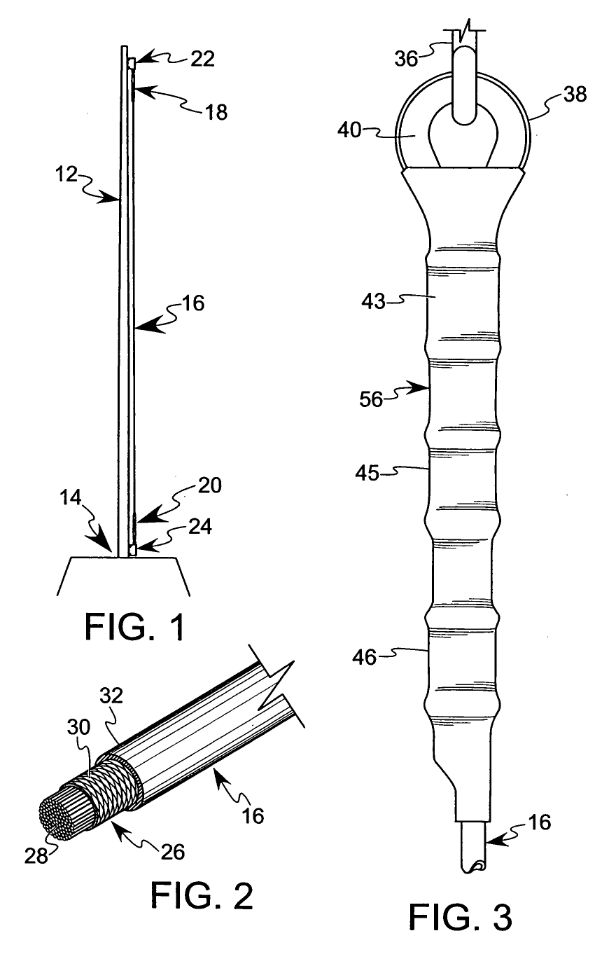

Referring to FIG. 1, the fall prevention construction 10 of the present invention is illustrated in combination with a vertical top mount antenna 12, such as may be mounted to the top of a television broadcasting tower 14 for emitting high power radio wave signals. The fall prevention construction includes a safety rope 16 having an upper, first end 18 and a lower, second end 20. The upper first end 18 of the safety rope 16 is attached to an upper anchor member 22, and the lower, second end 20 of the safety rope 16 is attached to a lower anchor member 24 to position the safety rope 16 in spaced relation to the antenna 12. The anchor members 22, 24 support the safety rope 16 on either side of a vertical section of the antenna 12 for emitting high power radio wave signals.

The safety rope 16 of the present invention is intended for use in combination with a security device to be engaged on the safety rope 16 for securely attaching a worker to the safety rope 16. An example of such a security device is described in U.S. Pat. No. 5,855,251, which patent is incorporated herein by reference.

Referring to FIG. 2, the safety rope 16 is shown in partial cross-section and generally comprises a synthetic blended polyester core rope. Specifically, in one embodiment, the rope 16 includes a so-called kernmantel dry rope 26 comprising a dry finish polyester core material 28 having parallel or twisted strands surrounded by a plaited polyester exterior sheath 30. An acceptable dry rope 26 for the present application is a rope sold under the DryCore™ name by Sterling Rope Company Inc. of Scarborough, Me., which is rated to withstand a 5000 pound static pull. In addition, the dry rope 26 is surrounded by a polyethylene jacket 32 which is preferably formed as an extruded covering over the dry rope 26.

The polyester dry rope 26 for the safety rope 16 of the present invention provides the characteristic of a water resistant core material to ensure that the interior of the safety rope 16 is free of moisture. The avoidance of moisture in the safety rope 16 is important in that water or moisture within the safety rope 16 could interact with the high energy radio waves emitted by the antenna 12, resulting in undesirable heating and possible deterioration of the safety rope 16. The polyester material of the dry rope 26 is further selected for its resistance to degradation in the presence of high energy radio waves as well as its lack of interference to the transmitted waves, while providing a strong, low-stretch support core for the safety rope 16.

The jacket 32 generally comprises a copolymer plastic material. Specifically, in one embodiment, the jacket 32 comprises a polyethylene copolymer for protecting the exterior of the dry rope 26 from the elements. The polyethylene copolymer of the jacket 32 is additionally substantially unaffected by the high energy radio waves produced by the antenna 12, and is resistant the ultraviolet rays of sunlight. Accordingly, the polyethylene jacket 32 provides an effective protective jacket for the dry rope 26 to ensure operational longevity of the safety rope 16.

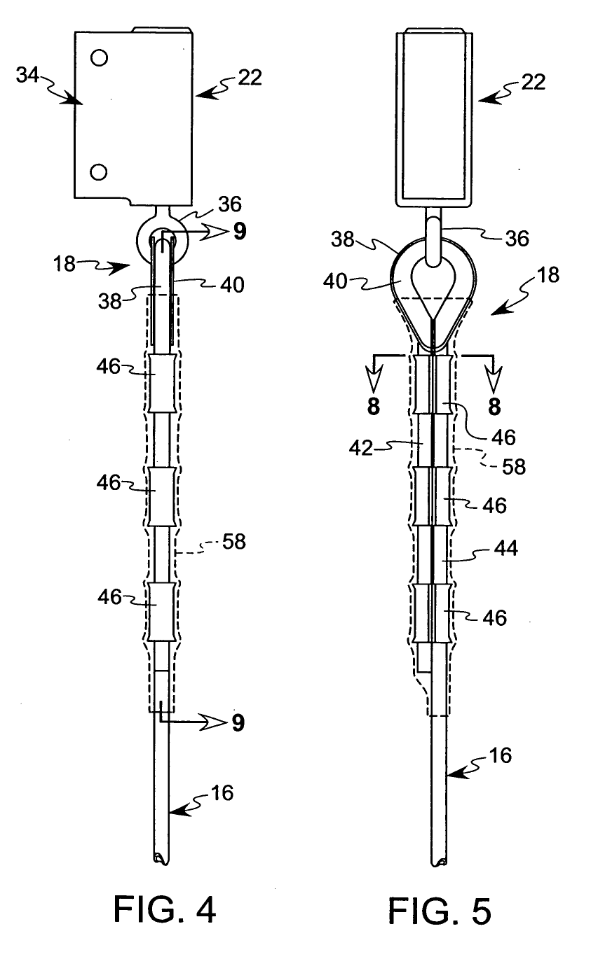

Referring to FIGS. 3-5, the upper anchor member 22 is illustrated, including its connection to the first end 18 of the safety rope 16. The upper anchor 22 comprises a pole mount head assembly 34 for attaching to the antenna 12 and for receiving and retaining an eye bolt 36.

The first end 18 of the safety rope 16 comprises a loop portion 38 formed through the eye portion of the eye bolt 36 and extending around a steel thimble 40 which engages with the eye bolt 36. A terminal portion 42 of the safety rope 16 extends down from one side of the loop 38 and lies parallel to a laterally adjacent section 44 of the safety rope 16 extending down from the other side of the loop 38.

The terminal portion 42 and laterally adjacent section 44 are retained in a predetermined position relative to each other, to permanently maintain the loop 38, by means of substantially identical copper sleeve members 46 which are swaged into frictional engagement with the terminal portion 42 and laterally adjacent section 44 of the safety rope 16. In the preferred embodiment, three sleeve members 46 are provided in spaced relation to each other located at three attachment regions 43, 45, 47 (see FIG. 1) to ensure secure retention of the safety rope 16 in the eye bolt 36. It should be noted that the present invention is not limited to use of sleeve members 46 formed of copper to the extent that other non-ferrous materials for the sleeve members 46 are available which have similar malleability to that of copper.

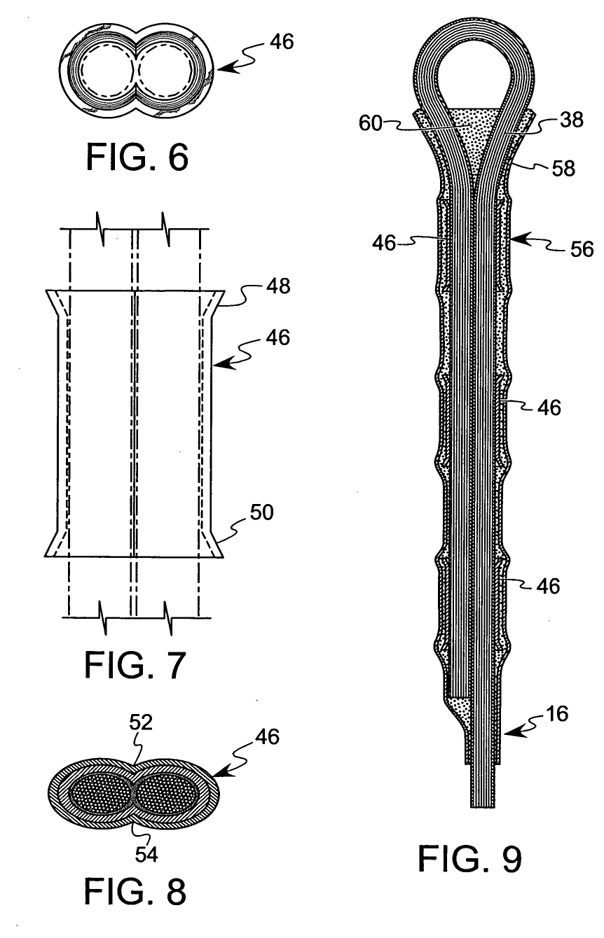

Referring to FIGS. 6 and 7, the sleeve members 46 used for the present invention have a generally oval cross-sectional shape to receive the terminal portion 42 and laterally adjacent portion 44 of the safety rope 16 in side-by-side relation. In addition, the ends 48, 50 of the sleeve members 46 are formed with an outwardly flared shape. The outwardly flared shape of the sleeve member ends 48, 50 provides an expanded interior passage for the terminal portion 42 and adjacent section 44 of the safety rope 16 within the sleeve member 46.

As illustrated in FIG. 8, the sleeve member 46 is swaged inwardly at opposed central portions 52, 54, extending longitudinally along the length of the sleeve member 46, to cause the sleeve member 46 to frictionally engage the terminal portion 42 and adjacent section 44 of the safety rope 16.

It should be noted that the sleeve members 16 are formed of copper because copper is a relatively malleable material which will not form fractures or cracks when sufficient force is applied to create the frictional engagement with the safety rope 16. The outwardly flared passages at the ends 48, 50 of the sleeve members avoids damage to the plastic material of the jacket 32 and well as to the material of the safety rope 16 during the swaging operation. In addition, the outwardly flared passages at the ends 48, 50 of the sleeve members 46 provide additional clearance space within the sleeve members 46 for accommodating movement of the polyethylene material of the jacket 32 as swaging pressure is applied through the sleeve members 46. It has been found that by providing the flared end passages, in combination with use of a relatively highly malleable material, e.g., copper, bulging of the material of the jacket 32 adjacent the ends of the sleeve members 46 can be avoided or minimized when performing the swaging operation. Avoidance of distortions of the jacket 32 is of particular importance in the application of the present invention in that maintenance of the integrity of the jacket is necessary to ensure long term protection of the dry rope 26 against moisture. It should be noted that protection against ingress of moisture into the safety rope 16 is particularly important in the area of the upper anchor member 22 where any moisture entering the jacket 32 could travel down between the jacket 32 and the dry rope 26 and pass into the area between the upper and lower anchor members 22, 24 where radio waves are emitted from the antenna 12.

In order to additionally ensure long term protection of the safety rope 16 against damage that may occur if moisture should pass through the jacket 32, a water barrier 56 is constructed around the terminal portion 42, the adjacent section 44 and the sleeve members 46, and extends down below the lower end of the terminal portion 42, as illustrated in FIG. 9. The water barrier 56 comprises a heat shrink cover 58, i.e., heat shrink tube, which is placed over the terminal portion 42, adjacent section 44 of the safety rope 16, the sleeve members 46 and extends up to a lower portion of the loop 38. After locating the heat shrink cover 58 in position, the cover 58 is heated to conform over the safety rope 16. A water repellant potting material 60 is subsequently injected to the interior of the cover 58 to fill the spaces between the cover 58 and the terminal portion 42, the adjacent section 44, and the sleeve members 46 and to additionally fill the area of the cover 58 adjacent the lower area of the loop 38 to provide further protection against entry of moisture at the locations where the material of the protective jacket 32 may be stressed by the sleeve members 46. Preferred materials for the potting material 60 comprise epoxy, RTV silicon, and equivalent materials capable of flowing into the spaces within the cover 58 and forming a water resistance barrier therein.

It should be understood that the lower, second end 20 of the safety rope 16 may be provided with a similar attachment configuration to that described for the upper end 18 of the safety rope 16.

Accordingly, it can be seen that in addition to providing a dry core safety rope 16, the present invention further ensures that the connection area of the safety rope 16, which experiences stresses to provide attachment to the tower structure 14, is provided with an additional protecting barrier against the elements.

While the form of apparatus herein described constitutes a preferred embodiment of this invention, it is to be understood that the invention is not limited to this precise form of apparatus, and that changes may be made therein without departing from the scope of the invention which is defined in the appended claims.

What is claimed is:

1. A fall prevention construction for permanent attachment to a vertical tower including a radio-frequency wave antenna, said fall prevention construction comprising:
a safety rope having first and second ends;
upper and lower anchor members for attachment to said first and second ends, respectively;
said safety rope comprising a dry finish polyester core material; and
an outer jacket formed over said safety rope for preventing moisture from contacting said safety rope.

2. The fall prevention construction of claim 1 wherein said dry finish polyester material comprises a waterproof treated core material.

3. The fall prevention construction of claim 1 wherein said outer jacket comprises a polyethylene copolymer.

4. The fall prevention construction of claim 1 wherein at least said first end of said safety rope is formed in a loop for connecting engagement with a cooperating member of said upper anchor member, and including a swaged sleeve attaching a terminal portion of said first end to a laterally adjacent section of said safety rope.

5. The fall prevention construction of claim 4 wherein said swaged sleeve includes opposing ends and each of said sleeve ends is flared outwardly, defining an expanded opening at each end of said sleeve.

6. The fall prevention construction of claim 4 wherein said swaged sleeve is formed of copper.

7. The fall prevention construction of claim 4 wherein said swaged sleeve is formed of an oval sleeve member, swaged inwardly along a longitudinal line extending substantially parallel to said terminal portion of said first end and said laterally adjacent section of said safety rope.

8. The fall prevention construction of claim 4 including a water barrier surrounding said swaged sleeve, said terminal portion of said first end and said laterally adjacent section of said safety rope.

9. The fall prevention construction of claim 8 wherein said water barrier comprises a tubular cover.

10. The fall prevention construction of claim 9 wherein said tubular cover is filled with a potting material.

11. The fall prevention construction of claim 10 wherein said potting material comprises epoxy or RTV silicon.

12. A fall prevention construction for permanent attachment to a vertical tower including a radio-frequency wave antenna, said fall prevention construction comprising:
a safety rope having first and second ends;
upper and lower anchor members for attachment to said first and second ends, respectively;
an outer jacket formed over said safety rope for preventing moisture from contacting said safety rope;
at least said first end of said safety rope is formed in a loop for connecting engagement with a cooperating member of said upper anchor member, said loop located adjacent a terminal portion of said first end and a laterally adjacent section of said safety rope; and
a water barrier surrounding said terminal portion of said first end and said laterally adjacent section of said safety rope.

13. The fall prevention construction of claim 12 wherein said water barrier comprises a tubular cover.

14. The fall prevention construction of claim 13 wherein said tubular cover is filled with a potting material.

15. The fall prevention construction of claim 14 wherein said potting material comprises epoxy or RTV silicon.

16. The fall prevention construction of claim 13 wherein said tubular cover comprises shrink tubing.

17. The fall prevention construction of claim 12 including a plurality of swaged sleeve members cooperate with a terminal end of said safety rope and a laterally adjacent section of said safety rope.

18. A fall prevention construction attached to a vertical tower including a radio-frequency wave antenna, said fall prevention construction comprising:
a safety rope having first and second ends;
upper and lower anchor members for attachment to said first and second ends, respectively;
said safety rope comprising a dry finish polyester core material
an outer jacket formed over said safety rope and extending substantially the length of said safety rope for preventing moisture from contacting said safety rope;
at least said first end of said safety rope is formed in a loop for connecting engagement with a cooperating member of said upper anchor member, said loop located adjacent a terminal portion of said first end and a laterally adjacent section of said safety rope;
sleeve members surrounding said terminal portion of said first end and said laterally adjacent section of said safety rope, where said sleeve members are swaged into contact with said terminal portion and said laterally adjacent section; and
a water barrier surrounding said terminal portion of said first end, said laterally adjacent section of said safety rope and said sleeve members, said water barrier comprising a potting material substantially filling spaces between said terminal portion, said laterally adjacent section and said sleeve members.
